(19) United States
(12) Patent Application Publication
(10) Pub. No.: US 2023/0389115 A1
(43) Pub. Date: Nov. 30, 2023

(54) SYSTEMS AND METHODS FOR MODEL MANAGEMENT

(71) Applicant: ZTE CORPORATION, Shenzhen (CN)

(72) Inventors: Hao WU, Shenzhen (CN); Huahua XIAO, Shenzhen (CN); Lun LI, Shenzhen (CN); Guozeng ZHENG, Shenzhen (CN); Yong LI, Shenzhen (CN); Yuxin WANG, Shenzhen (CN); Zhaohua LU, Shenzhen (CN)

(73) Assignee: ZTE CORPORATION, Shenzhen (CN)

(21) Appl. No.: 18/331,629

(22) Filed: Jun. 8, 2023

Related U.S. Application Data
(63) Continuation of application No. PCT/CN2021/132245, filed on Nov. 23, 2021.

(51) Int. Cl. H04W 76/25; H04W 28/02; H04W 72/1268; H04W 72/20

(52) U.S. Cl. CPC H04W 76/25; H04W 72/20; H04W 72/1268; H04W 28/0236

(57) ABSTRACT

Presented are systems and methods for model management. A wireless communication device can send a first indication to initiate an update of a model to a wireless communication node. The wireless communication device can receive a second indication to trigger an uplink transmission from the wireless communication node. The wireless communication device can receive information for updating the model from the wireless communication node.

### CROSS-REFERENCE TO RELATED APPLICATION

This application claims the benefit of priority under 35 U.S.C. § 120 as a continuation of PCT Patent Application No. PCT/CN2021/132245, filed on Nov. 23, 2021, the disclosure of which is incorporated herein by reference in its entirety.

### TECHNICAL FIELD

The disclosure relates generally to wireless communications, including but not limited to systems and methods for model management.

### BACKGROUND

In the 5th Generation (5G) New Radio (NR) mobile networks, a user equipment (UE) can send data to a base station (BS) by obtaining uplink synchronization and downlink synchronization with the BS. The uplink timing synchronization can be achieved by performing a random access procedure. The UE can transmit a reference signal to the BS. The BS can perform measurements of the signal received from the UE. The BS and/or the UE can use the results of the measurements to determine the quality of the wireless channel.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device (e.g., UE) can send a first indication to initiate an update of a (e.g., machine learning, artificial intelligent, and/or neural network) model to a wireless communication node (e.g., base station). The wireless communication device can receive a second indication to trigger an uplink transmission from the wireless communication node. The wireless communication device can receive information for updating the model from the wireless communication node.

In some implementations, the first indication can include a request to update a parameter set of the model or to train the model. In some implementations, the first indication can include a measurement result or an indication of the measurement result satisfying a threshold criteria. The measurement result can include a signal-to-noise ratio (SNR) of a physical downlink shared channel (PDSCH), a block error rate (BLER), a modulation and coding scheme (MCS), or a channel quality indicator (CQI).

In some implementations, the first indication may be at least one of included in a periodic report, included in uplink control information (UCI), included in a medium access control control element (MAC CE), carried in a first physical uplink shared channel (PUSCH) or physical uplink control channel (PUCCH), or jointly coded with a scheduling request (SR) in at least one SR resources or at least one PUCCH resources for the SR. In some implementations, the wireless communication device can send an SR carried in a second PUSCH or PUCCH prior to sending the first indication in the MAC CE that is carried in the PUSCH.

In some implementations, the uplink transmission can include an uplink transmission of at least one reference signal (RS), or a report comprising assistance information. In some implementations, the wireless communication device can receive the second indication in a radio resource control (RRC), medium access control control element (MAC CE) or downlink control information (DCI) signaling from the wireless communication node. The wireless communication device can perform the uplink transmission to the wireless communication node, responsive to the second indication.

In some implementations, the wireless communication device can perform the uplink transmission a defined duration after receiving the second indication or after transmitting a hybrid automatic request acknowledgment (HARQ-ACK) of a physical downlink shared channel (PDSCH) or physical downlink control channel (PDCCH) carrying the second indication. In some implementations, if the wireless communication device does not receive the second indication within a defined duration after sending the first indication, the wireless communication device can resend the first indication to initiate an update of the model to the wireless communication node.

In some implementations, a pattern of the uplink transmission may be predefined or configured via a signaling from the wireless communication node. The pattern may include at least one of a periodicity of the uplink transmission, a number of occasions of the uplink transmission, or a time gap between adjacent occasions of the uplink transmission. In some implementations, the wireless communication node can configure at least one of a channel state information (CSI) configuration, or information on sounding reference signal (SRS) resource or SRS resource set, associated with updating the parameter set of the model or training the model.

In some implementations, the wireless communication device can terminate the uplink transmission responsive to receiving: a signaling comprising the information for updating the model, or a defined signaling. In some implementations, the assistance information comprises at least one of information related to a relative location of the wireless communication device in one or more cells, information related to at least one large scale parameter of the wireless communication device, or information related to a model structure of the wireless communication device. In some implementations, the information related to a relative location of the wireless communication device in one or more cells can include at least one of time advance (TA), round trip time (RTT), angle of departure (AoD), or time difference of arrival (TDOA).

In some implementations, the information related to at least one large scale parameter of the wireless communication device can include at least one of average delay, delay spread, average angle, angular spread, or average gain. In some implementations, the information related to the model structure can include at least one of a first number of nodes, a number of layers, or a second number of nodes for each layer.

In some implementations, the information for updating the model can include training data for training the model, or an updated parameter set for the model or an indication thereof. In some implementations, the wireless communication device can receive the information for updating the model via a radio resource control (RRC), medium access control control element (MAC CE) or downlink control information (DCI) signaling from the wireless communication node.

In some implementations, if the wireless communication device does not receive the information for updating the model within a defined duration after sending the uplink transmission or the first indication, the wireless communication device can resend the first indication to initiate an update of the model to the wireless communication node. In some implementations, the updated parameter set for the model comprises a subset of a current parameter set for the model.

In some implementations, the wireless communication device can receive at least one signaling carrying a compressed or quantized version of the information for updating the model from the wireless communication node. In some implementations, the wireless communication device can recover the information from the compressed or quantized version, using a predetermined structure.

At least one aspect is directed to a system, method, apparatus, or a computer-readable medium. A wireless communication node can receive a first indication to initiate an update of a model from a wireless communication device. The wireless communication node can send a second indication to trigger an uplink transmission to the wireless communication device. The wireless communication node can send information for updating the model to the wireless communication device.

The systems and methods presented herein include a novel approach for model management. Specifically, the systems and methods presented herein discuss a novel solution for training and/or updating models. For example, the user equipment (UE) (e.g., wireless communication device) can request for (e.g., reporting a need of) a model update or training. The UE can report/transmit/send at least one of a model parameter set update request or a training request (e.g., first indication or report) for training one or more models.

In some implementations, the report may be a request or other signaling by the UE, such as for model update or training. The report can be included/contained/embedded in UCI (e.g., channel state information (CSI)) carried/communicated in/via a physical uplink shared channel (PUSCH) or physical upnlink control channel (PUCCH). In some cases, the report can be included in MAC CE signaling carried in/via a PUSCH. In this case, the UE may transmit/send/provide a scheduling request (SR) carried in/via a PUCCH or PUSCH to a node (e.g., wireless communication node, radio node (gNB), or base station (BS)) prior to/before transmitting the PUSCH including/containing/carrying the MAC CE signaling. Accordingly, the gNB can schedule a PUSCH to carry the MAC CE signaling in response or subsequent to receiving the SR from the UE. In some cases, the report can be jointly coded with a SR in one or more SR resources or PUCCH resources for SR.

In some implementations, the report may be a reporting of measurement results, or an indicator when the measurement result is lower or higher than a threshold (e.g., exceeds, satisfies, or goes beyond an upper bound or a lower bound of a threshold criteria). The threshold can be fixed/predetermined/predefined or configured by the gNB. The measurement results may include, but are not limited to at least a physical downlink shared channel (PDSCH) signal to noise ratio (SNR), block error rate (BLER), modulation and coding scheme (MCS), channel quality indicator (CQI), among others. In some cases, the gNB can configure/modify/provide a dedicated set of the reference signal (RS) (e.g., PDSCH demodulation reference signal (DMRS) or CSI-RS) for measuring the parameters (e.g., model parameter set).

In some implementations, if the report is a reporting of measurement results, the report can be contained in a periodic (e.g., periodically scheduled/transmitted) report in UCI carried in a PUSCH/PUCCH, or MAC CE signaling carried in a PUSCH. In some cases, the report may be an aperiodic UCI report in a PUSCH/PUCCH, or a MAC CE signaling carried in a PUSCH. Prior to transmission of the MAC CE signaling in the PUSCH, the UE can transmit an SR carried in a PUCCH/PUSCH, and the gNB can schedule a PUSCH to carry this MAC CE signaling.

In some implementations, if the report is a reporting of an indicator when the measurement result is lower or higher than the threshold (e.g., satisfies the threshold), the report may be a UCI (e.g., CSI) in a PUSCH or PUCCH. In some cases or alternatively, the report may be a MAC CE signaling carried in a PUSCH. Before/prior to transmitting the MAC CE signaling in PUSCH, the UE may transmit an SR carried in a PUCCH or PUSCH, such as for the gNB to schedule a PUSCH to carry the MAC CE signaling. In some cases, the report can be jointly coded with SR in one or more SR resources (or PUCCH resources for SR).

The gNB can trigger UE assistance information reporting or UL RS transmission in/via a radio resource control (RRC), MAC CE, or downlink control information (DCI) signaling (e.g., for triggering the UE to provide the assistance information or UL RS transmission). The gNB can initiate/perform the triggering by transmitting a second indication to the UE. The UE can provide/transmit/send assistance reporting or UL RS transmission upon/in response/subsequent to receiving the triggering from the gNB. The UE may initiate transmission of the UL RS (e.g., SRS) or assistance information N mini-seconds (or N slots, N orthogonal frequency division multiplexing (OFDM) symbols, or an N predetermined/predefined duration) after receiving the triggering, or N mini-seconds after transmitting a hybrid automatic request acknowledgment (HARQ-ACK) of the PDSCH or PDCCH containing/carrying the triggering signal. The value of N can be/represent a fixed/predefined value or indicated in a gNB signaling. For example, N can be indicated in the triggering signaling (e.g., MAC CE or DCI).

In some cases, if the UE does not receive such a triggering signal from the gNB L mini-seconds (or L slots, L OFDM symbols, or L predetermined duration) after the UE sends the training request or model parameter update request (e.g., the report), the UE may re-send the request or report. The UL RS or assistance information may contain one occasion which locates N mini-seconds after receiving the triggering, or N mini-seconds (or N slots or N OFDM symbols) after transmitting HARQ-ACK of the PDSCH or PDCCH containing the triggering signaling. In some implementations, the pattern of the UL RS or assistance information report can be predetermined or configured by signaling from the gNB. The pattern may include the periodicity of the UL RS or assistance information report, the number of occasions (e.g., number of times or frequency) of the UL RS or assistance information report, and/or the time gap between two adjacent occasions of the UL RS or assistance information report.

In some implementations, the gNB may configure the CSI report configuration, SRS resource, and/or SRS resource set information associated with the usage/implementation of model parameter update or model training. In some cases, gNB may use the signaling (e.g., MAC CE) which carries/includes the training data or updated model parameter set, or in dedicated signaling, to terminate the UL RS transmission or assistance information report.

The content of the assistance information report can include various information. For example, the content may be related to/associated with a relative location/region/position of the UE in a cell (or multiple cells), such as time advance (TA), round trip time (RTT), angle of departure (AoD) (e.g., DL AoD), or time difference of arrival (TDOA), etc. In another example, the content can include information regarding large-scale parameters of the UE, such as average delay, delay spread, average angle, angular spread, average gain, etc. In some cases, the gNB can configure a dedicated set of CSI-RS (or TRS) for measuring/obtaining/determining the assistance information. In some cases, the gNB can configure/modify/edit/organize/restructure the content of the assistance information report, such as provided by the UE.

The gNB can transmit training data or updated model parameter set to the UE in DL signaling (e.g., RRC or MAC CE). In some cases, if the UE does not receive such transmission signaling within/during/by M mini-seconds (or M slots, M OFDM symbols, or M predetermined duration) after the transmission of the assistance information or UL RS (e.g., after the UE transmits the training request or model parameter update request), the UE can re-send the request or report to the gNB. The training data (e.g., for the gNB and/or the UE to train at least one model) can include at least input and/or output data used in the model, control/controlling factors (e.g., compression rate, learning rate, step interval, etc.) of the model, data structure (e.g., number of batches), or structure of the model (e.g., number of layers or nodes within the model, weights applied to the layers or nodes, etc.). The model parameter set can include at least the coefficients/values used in the model, controlling factors (e.g., compression rate, activation function, etc.) of the model, or structure of the model (e.g., number of layers or nodes, etc.).

In some implementations, the updated model parameter can be a subset of the current model parameter (e.g., Parameter set 1, or a first parameter set out of multiple parameter sets before the update). In this case, the gNB can indicate in the DL signaling which subset (or which ones) of the parameters is updated. In some cases, the transmission of training data or model parameter set may use a compression mechanism (e.g., compression coding) to compress the training data or model parameter set before transmitting. For instance, the gNB can transmit the training data or model parameter set using (e.g., after applying) compression coding, among other codings. In some cases, the transmission of training data may use a predetermined structure (e.g., model, codebook, etc.). The gNB can quantize (and/or compress) the training data based on the structure (e.g., model, codebook) and can transmit/send the quantized (and/or compressed) data, such as to the UE. The UE can reconstruct/recover the training data from the quantized and/or compressed version based on the predetermined structure (e.g., model, codebook) and the received data (e.g., quantized or compressed data) from the gNB.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example of two levels of parameter sets, in accordance with some embodiments of the present disclosure;

FIG. 4 illustrates an example flow chart for model management without online training, in accordance with some embodiments of the present disclosure;

FIG. 5 illustrates an example flow chart for model management with online training, in accordance with some embodiments of the present disclosure; and

FIG. 6 illustrates a flow diagram of an example method for model management, in accordance with an embodiment of the present disclosure.

### DETAILED DESCRIPTION

### 1. Mobile Communication Technology and Environment

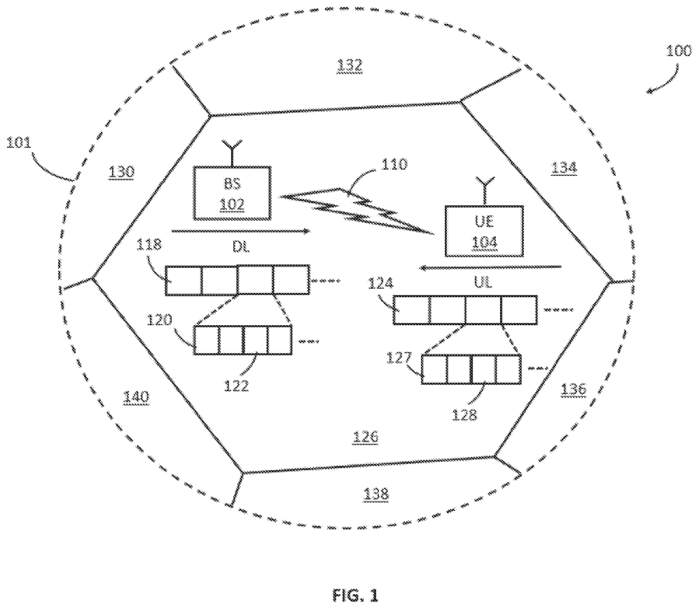

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

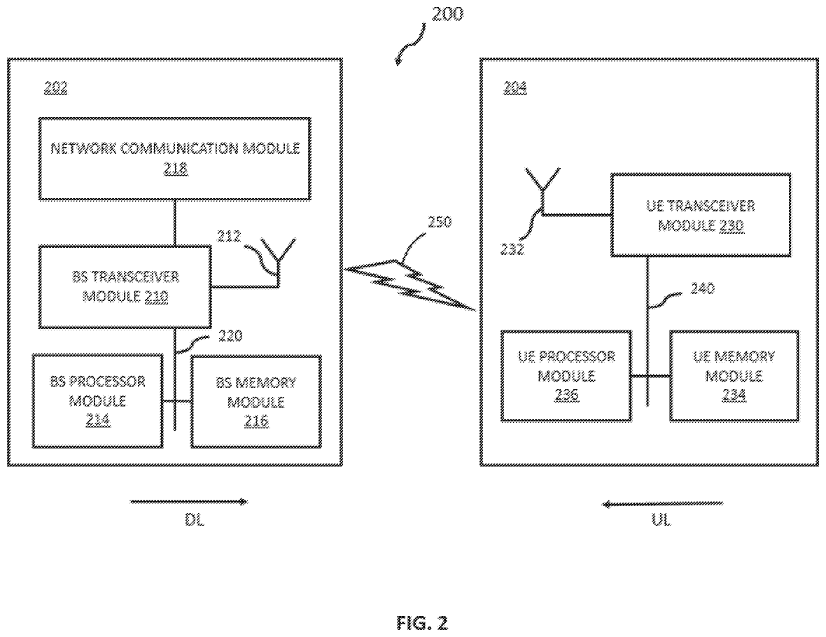

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistance (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support Internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Model Management

In certain systems (e.g., 5G new radio (NR), Next Generation (NG) systems, 3GPP systems, and/or other systems), artificial intelligence (AI) and/or machine learning (ML)-based technologies can be applied in various wireless mobile communication technologies or use cases to achieve higher accuracy, higher capacity, lower overhead, or lower latency, among other improvements. A trained model (e.g., AI model, ML model, or neural network model) can provide improved performance communicating between one or more UEs and BSs, such as when the application or the inference of the model can match the wireless channel properties (e.g., parameters or characteristics of the wireless channel). As wireless channels may change dynamically with respect to the propagation environment, for instance, due to the movement/shift of the UE, the model may need to be updated. Hence, managing parameters of the model to reflect/match/account for the dynamic change of wireless channels can be crucial to maintain good performance of the AI/ML-based approach/technologies in the application of wireless communication.

In certain systems, the application of AI/ML-based approaches in wireless communication technologies can be exploited or used to facilitate communication between UE (e.g., wireless communication device) and gNB (e.g., BS or wireless communication node). The AI/ML can be beneficial in various implementations/cases including, for instance, channel state information (CSI) reporting, beam management, channel estimation, positioning, mobility, scheduling, channel coding, etc. For example, the gNB and/or the UE may use the model to measure/determine/identify/predict the characteristics of the wireless channel, movement of the UE (e.g., direction, velocity/speed, constant or non-constant acceleration, subsequent location, etc.), among others. The gNB and/or UE can use results/output/prediction/determination from the model for beam steering, transmission scheduling (e.g., scheduling UL or DL transmission at a certain time and/or certain frequency rate), determination of channel coding used for UL or DL communication, among other tasks between the gNB and UE. Hence, the UE and/or the gNB, among other wireless communication systems, can use model and/or AI/ML-based approach to obtain the benefit of, but not limited to at least one of: higher capacity/resources, higher accuracy, higher reliability, higher robustness, lower overhead, or lower latency in wireless communication (e.g., data transmission between devices or nodes).

The utilization of AI/ML-based approaches may include one or more phases, such as model training and model inference. A trained model can be used in wireless communication systems, such as in the inference phase of the model deployment. To improve the operability of wireless communications using a model, the historical/used model parameters may be trained to match the wireless channel environment. As wireless channel may change dynamically with respect to/concerning the propagation environment (e.g., condition/environment experienced by the gNB and/or the UE, activities by the UE, etc.), the gNB can update/manage/configure/modify the model accordingly. The gNB may update the model used by the gNB and/or the UE. In some cases, the UE can update the model, or both gNB and the UE can include features, functions, or operations to update/manage the model. Managing the model parameters to match the dynamic change of the wireless channel can provide/maintain/facilitate the performance of AI/ML-based approach for wireless communication.

In some cases, the model management can include, correspond to, or be a part of model life cycle management, which may include model deployment, data collection, model training, model update, model adaption, model transmission, model deployment, etc. As training or model transmission may consume large computation power or high air interface overhead, the trade-off among at least performance, air interface overhead, and UE complexity is considered. Hence, the systems and methods discussed herein can further provide efficient trade-offs between the overheads, complexity, and/or performance of the model.

To perform AI/ML operations on wireless communication systems, the AI/ML model for inference can be trained. Inference can refer to at least one of operating, using, applying, performing, executing, or running the model in wireless communication systems, where the output/result/determination/prediction of the model can be used to improve the wireless communication quality or other factors within the communication between wireless entities (e.g., wireless communication devices or wireless communication nodes). The model may be represented/implemented by, correspond to, or include a set of model parameters, which may include a certain model structure obtained from the training process. The model structure can include one or more model parameters, such as the number of layers, the number of nodes in each layer, the weight associated with individual layers and/or nodes, filters applied to one or more layers, etc.

The training of the model can refer to or include a process/operation/method to obtain/acquire/optimize/generate the set of model parameters. The input data of the model in the training process can reflect/produce/known by the output end (e.g., results from the model, output data, or processed data). The set of model parameters may be derived by using the input data and output data. The training of the model may be categorized into two types, such as online training and offline training. For example, online training can include or refer to performing the model training processes using/costing/incurring real-time or in-band air interface resources. In another example, offline training can include performing the training through implementation, which may not receive/incur/cost real-time (e.g., live data/transmission from the UE or the gNB) or in-band air interface resources. In this case, the UE and/or the gNB can implement/use historical data, existing data, output data, and/or local data for training the model.

In some implementations or use cases of the model (or AI) in wireless communications, the model may be deployed/maintained on the gNB side. In this case, for example, the gNB can update and/or manage model parameters during the implementation of the model. The gNB can receive assistance information from the UE, where the gNB can use the assistance information to update/improve/generate model parameters or for training the model. In some implementations, the model may be deployed in the UE. For instance, in this case, the UE can receive an update and/or management of model parameters from the gNB, or be trained in conjunction with (or by assistance from) the gNB. In some cases, the UE may perform one or more features or functionalities of the gNB to update, train, or otherwise manage the model.

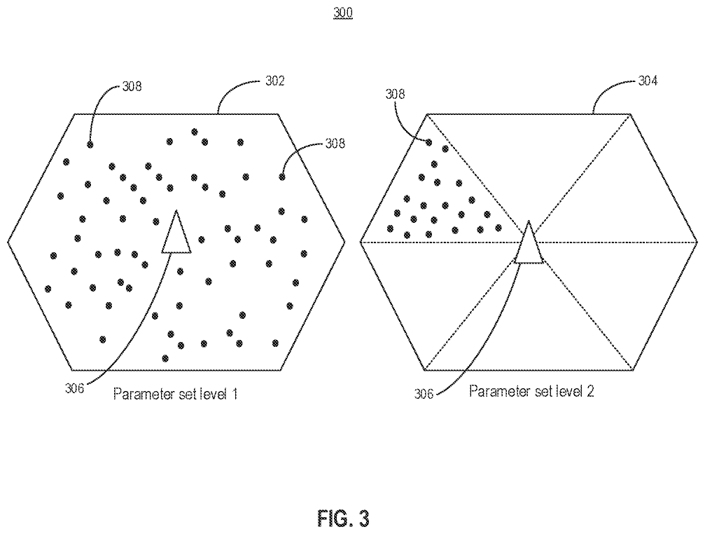

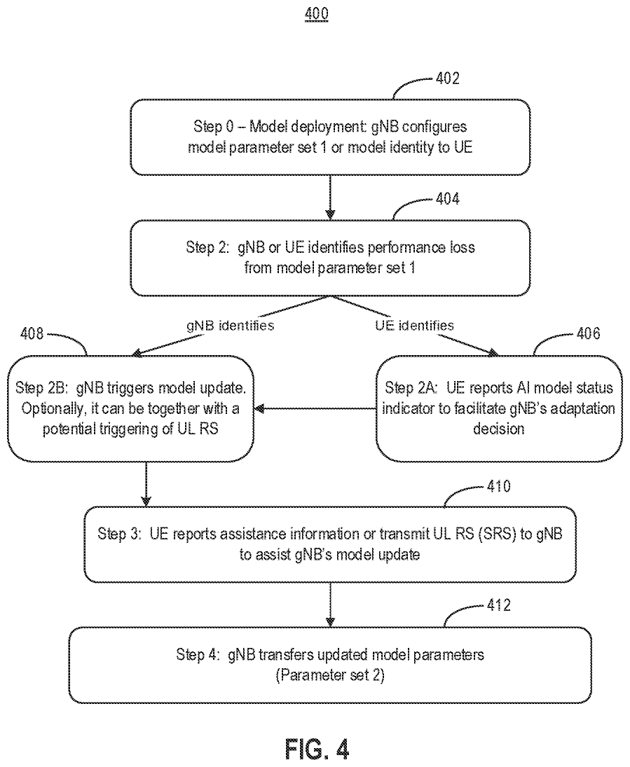

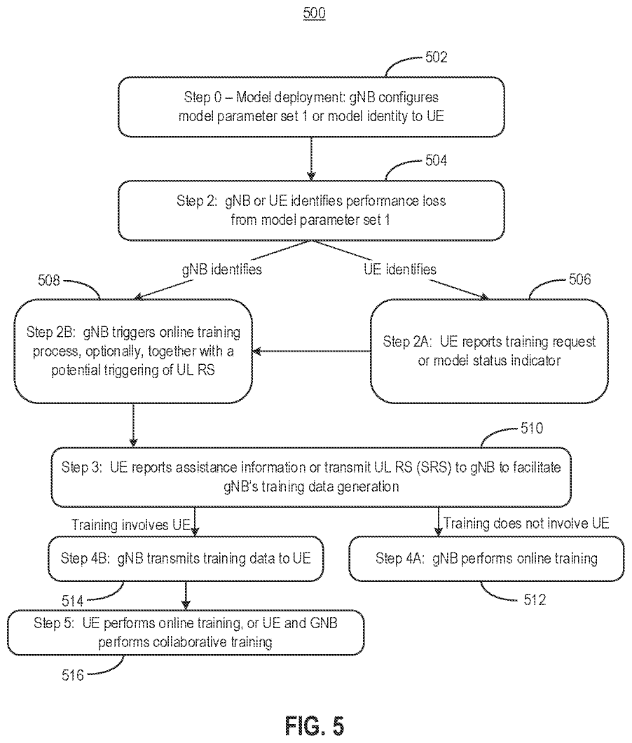

In some implementations, the model can be deployed/used/implemented in both UE and gNB. For example, the types of model can include an encoder at the UE side and a decoder at the gNB side. The model update/management of the model type may include characteristics of at least one of the model types. For example, the UE may report assistance information to the gNB to assist/facilitate the gNB when updating the model. The gNB may transmit the updated model parameters or training data to the UE, such as to assist model updating or training at the UE-side. The example operations by at least the UE or the gNB for model management are discussed herein, such as without online training in conjunction with at least FIGS. 3-4, and with online training in conjunction with FIG. 5.

### A. Implementation 1: Model Management Without Online Training

Referring to FIG. 3, depicted is an example 300 of two levels of parameter sets. The two levels of parameter sets can include at least parameter set level 1 (e.g., parameter set 302) and parameter set level 2 (e.g., parameter set 304). The parameter sets can correspond to, include, or be part of the model (e.g., AI model). The illustration of the two levels of parameter sets can include at least one gNB 306 (e.g., BS or wireless communication node) and various UEs 308 (e.g., wireless communication devices). The gNB 306 can include features and/or perform operations similar to at least BS 102 and/or BS 202 in conjunction with at least FIGS. 1-2. The UE 308 can include features and/or perform operations similar to at least UE 104 and/or UE 204 in conjunction with at least FIGS. 1-2.

The two levels of parameter sets can be used for performing model management without online training. To perform model management or train the model without online training, the gNB 306 may be configured to store multiple levels of model parameter sets. Different levels of model parameter sets can provide/indicate/present/support different levels of robustness and/or peak performance. For instance, the gNB 306 can store the two levels of model parameter sets, such as the parameter set 302 or parameter set 304. The parameter sets can be trained using/through offline training.

The gNB 306 can train the parameter set 302 from various points in one or more cells (e.g., area/radius/region around/surrounding the gNB 306, such as cells 126 in conjunction with FIG. 1), which the parameter set 302 can be common for the UEs 308 within the one or more cells. For example, the UE 308 can enter into the cell. The gNB 306 can transmit/provide/send the parameter set 302 (sometimes referred to as a model parameter set) to the UE 308 in response to entering the cell. In some cases, the UE 308 may store the parameter set 302 (e.g., locally stored on UE-side). In this case, the gNB 306 can configure or send a model identity (ID) to the UE 308 entering into the cell. For instance, to update or train the model for the UE 308, the gNB 306 can indicate which model for the UE 308 to use or the parameter set for updating the model based on the model ID.

The gNB 306 can train to output the parameter set 304 from various points from a sub-region of a cell. For instance, the cell can include six regions within the example 300 indicated in parameter set 304. The parameter set 302 can include multiple sub-regions, such as six regions similar to the parameter set 304. A sub-region (e.g., a portion of the cell) of parameter set 304 may include more/greater number of training points than a sub-region of parameter set 302. For instance, with six parameter sets associated with the respective six regions, each of the parameter sets of parameter set 304 can include more training points compared to each of the parameter sets of parameter set 302. There may be more or less the number of sub-regions of or included in a cell, such as three, four, eight, ten, etc. regions. The gNB 306 can switch/swap between the usage of parameter set 302 and parameter set 304. The gNB 306 can transmit/send the parameter set 304 to the UE 308 for updating or training the model, such as in response to receiving an update or training request from the UE 308. The deployment of the multi-level parameter sets (e.g., parameter set level 1 and parameter set level 2) for model management, the gNB 306 and/or the UE 308 can perform features or functionalities in conjunction with at least FIG. 4.

Referring to FIG. 4, depicted is an example flow chart 400 for model management without online training. The flow chart 400 can include various steps and/or operations to train the model or update model parameters for the gNB 306 and/or the UE 308. In some implementations, the executing/performing/initiating model management without online training may use/include any subset of the steps/operations and/or in any order. At step 402, the model can be deployed at the parameter set 302 (e.g., parameter set 1). In some cases, the gNB 306 can transmit/configure/provide the parameters in parameter set 1 to UE through RRC (or MAC CE) signaling. In some other cases, the gNB 306 can configure a model ID (e.g., parameter set ID) to UE 308 in RRC (or MAC CE). For instance, the UE 308 can use the model ID to retrieve one or more parameters stored locally, such as in memory, table, data repository, etc. The gNB 306 can provide the model ID to the UE 308 in response to the UE 308 entering the cell or based on the configuration of the gNB 306.

At step 404, the gNB 306 and/or the UE 308 can identify performance loss from using model parameter set 1. The performance loss can refer to the degradation of performance in communication between the gNB 306 and the UE 308 (or other UEs 308). The performance loss can be on the gNB 306 or the UE 308 side. The gNB 306 and/or UE 308 can identify the performance loss based on monitoring one or more metrics of the wireless system (e.g., wireless channel, wireless connection, etc.). For example, UE 308 can monitor/identify/observe the reception performance (e.g., DL signal performance) of certain DL channels or signaling based on metrics, such as PDSCH SNR, block error rate (BLER), modulation and coding scheme (MCS), channel quality indicator (CQI), etc. In response to the UE 308 identifying the performance loss from parameter set 1, the UE 308 can proceed to perform features of step 406 in response to identifying the performance degradation. In some cases, the performance degradation/loss may be identified/determined by the gNB 306. In response to identifying the performance loss, the gNB 306 can proceed to perform features of step 408.

At step 406, the UE 308 can report (e.g., a first indication) to the gNB 306 for triggering a model update (e.g., request a model update). The UE 308 can report the model status indicator to facilitate gNB 306's adaptation decision in updating the model responsive to performance degradation. For example, the UE 308 can generate/provide the report including or corresponding to a model parameter update request. For example, the report can be included/contained in UCI (e.g., CSI) carried in a PUSCH or PUCCH. In some cases, the report can be included in or correspond to a MAC CE signaling carried in a PUSCH. For instance, prior to the transmission of the PUSCH, the UE 308 can provide/transmit an SR carried in a PUCCH or PUSCH to the gNB 306. In response to receiving the SR, the gNB 306 can schedule a PUSCH to carry/include the MAC CE signaling. In some other cases, the report may be jointly coded with SR in one or more SR resources or at least one PUCCH resources for SR.

In some implementations, the UE 308 can report the measurement results (e.g., measurement or data of the performance loss/degradation from using parameter set 1) or an indicator/alert when the measurement result satisfies a threshold (e.g., lower or higher than, and/or equal to a performance threshold/range, which can be fixed/predetermined/predefined/configured by the gNB 306). The measurement results can include at least one of PDSCH SNR, BLER, MCS, or CQI, among others. In some cases, the gNB 306 can configure a dedicated set of RS (e.g., defined signaling, dedicated signaling, PDSCH DMRS, or CSI-RS) for measuring the parameters (e.g., parameters of at least parameter set 1).

If the reporting includes the measurement results, the report may be included/contained in a periodic report in UCI carried in PUSCH/PUCCH, or MAC CE signaling carried in PUSCH. In some cases, the report may be included in an aperiodic UCI reported/sent in PUSCH or PUCCH, or a MAC CE signaling carried in PUSCH. Prior to transmission of the MAC CE signaling in PUSCH, the UE 308 may transmit an SR carried in a PUCCH or PUSCH to the gNB 306, such that the gNB 306 can schedule a PUSCH to carry the MAC CE signaling for the UE 308.

In some implementations, if the reporting includes an indicator when the measurement result satisfies the threshold, the report may be a UCI (e.g., CSI) in PUSCH or PUCCH. In some cases, the report can be a MAC CE signaling carried in a PUSCH. Prior to/before transmission of the MAC CE signaling in the PUSCH, the UE 308 may send an SR carried in a PUCCH or PUSCH for the gNB 306 to schedule a PUSCH to carry the MAC CE signaling. In some other cases, the report may be jointly coded with SR in one or more SR resources or PUCCH resources for SR.

At step 408, the gNB 306 can trigger a model update or adaption (e.g., model parameter set update). The gNB 306 can trigger the update in response to identifying the performance loss and/or receiving an indication of performance loss from the UE 308. In some cases, the gNB 306 can trigger the update subsequent to the UE identifying the performance loss. In some cases, the gNB 306 can trigger the update prior to receiving an indication of model status from the UE 308. The trigger can be indicated in RRC, MAC CE, or DCI signaling. The gNB 306 triggering the update can prompt/trigger/request the UE 308 to report/provide assistance information or UL RS transmission for the gNB 306, such as in step 410.

In some implementations, if the UE 308 does not receive the triggering signaling, for instance, L mini-seconds, L slots, or L OFDM symbols after the UE 308 sends the model update request (e.g., in step 406), the UE 308 may re-send the request to update the model to the gNB 306. The L can represent a value or time of mini-seconds configured for the re-transmission of the update request.

At step 410, the UE 308 can transmit assistance reporting or UL RS transmission upon/in response to/subsequent to receiving gNB triggering or signaling of the model update. For example, the UE 308 can initiate a transmission of UL RS (e.g., SRS) or assistance information (and/or raw data) at the slot or OFDM symbols, such as N mini-seconds, N slots, or N OFDM symbols subsequent to receiving the triggering from the gNB 306. The SRS can be used to determine/identify/obtain at least information regarding channel strength, signal fluctuations, the direction of the signal, latency during transmission, etc. The gNB 306 can use the assistance information or raw data from the UE 308 to update the model, obtain an updated parameter set, and/or transfer/provide an updated set of parameters to the UE 308, for example. In some cases, the UE 308 can initiate the transmission in response to N mini-seconds, N slots, or N OFDM symbols after transmitting a HARQ-ACK of the PDSCH or PDCCH containing the triggering signaling. The N can be a predetermined/fixed/predefined value or indicated in a gNB signaling. For example, the gNB 306 can include/indicate the N in the triggering signaling (e.g., MAC CE or DCI).

The UE 308 can transmit a UL RS or assistance information to the gNB 306 in/via one or more patterns. The UL RS or assistance information can include one occasion (e.g., time) which locates N mini-seconds, N slots, or N OFDM symbols, and/or N mini-seconds, N slots, or N OFDM symbols after transmitting HARQ-ACK of the PDSCH or PDCCH including/containing the triggering signaling. The pattern of UE transmission of the UL RS or assistance information report may be predetermined or configured by signaling from the gNB 306. The pattern can include at least one of: the periodicity of the UL RS or assistance information report, the number of occasions (e.g., number of times or frequency) of the UL RS or assistance information report, or the time gap between two adjacent occasions (e.g., continuous or proximal occasions) of the UL RS or assistance information report.

In some implementations, the gNB 306 can configure the CSI report configuration. The SRS resource and/or SRS resource set information can be associated with the usage/utilization/implementation of model parameter update. The gNB 306 can use the signaling (e.g., MAC CE), such as in step 412 (e.g., the signaling carrying the model parameter transmission) or in new dedicated signaling, to terminate the UL RS transmission or assistance information report. In some cases, the content of the assistance information report may be used by the gNB 306 to determine the updated model parameter set (e.g., parameter set 2). For example, the assistance information can be related to/associated with the relative location/region/position of the UE 308 in the cell or multiple cells, such as TA, RTT, DL AoD, TDOA, etc. In another example, the information may be related to large-scale parameters of the UE 308, such as the average delay, delay spread, average angle, angular spread, average gain, etc.

In some implementations, the gNB 306 can configure/provide a dedicated set of CSI-RS or tracking reference signal (TRS) for measuring/determining the assistance information from the UE 308. In some cases, the gNB 306 can configure/modify the content of the assistance information report.

At step 412, the gNB 306 can transmit the updated model parameter set to the UE 308 in a DL signaling (e.g., RRC or MAC CE). The gNB 306 can transmit the updated model parameter set in response to/subsequent to/after receiving the reported assistance information or UL RS from the UE 308. In some cases, if the UE 308 does not receive the transmission signaling from the gNB 306 in/by M mini-seconds, M slots, or M OFDM symbols after the transmission of the assistance information or UL RS (e.g., in conjunction with step 410), or after the UE 308 transmits the model update request in step 406, the UE 308 can re-send the model update request to the gNB 306.

The updated model parameter can include at least one of: the coefficients used in the model, controlling factors (e.g., compression rate, activation function, etc.) of the model, or structure of the model (e.g., number of layers or nodes, applied weights, etc.). In some cases, the updated model parameter can be a subset of the currently used model parameter (e.g., parameter set 1 or a portion of parameter set 2). The gNB 306 can indicate/notify/alert in the DL signaling to the UE 308 that the subset (e.g., a subset of parameters) is updated. In some cases, the transmission of the updated model parameter set may use a compression mechanism (e.g., compression coding) to reduce the payload size for sending the updated model parameter set. In this case, the UE 308 can experience less overhead, traffic, or load with the gNB 306 using the compression mechanism. The transmission can be carried in SRB and/or control plane.

In some implementations, for the gNB 306 to update the model parameter set, the gNB 306 can train/update the model based on the assistance information report of the UE 308 or UL RS. For example, the UE 308 can report information regarding/indicating the model structure or capability, such as the number (e.g., at least the maximum number) of layers, the number (e.g., maximum number) of nodes, and/or the number (e.g., maximum number) of nodes per layer within the model. The information regarding the model structure can be reported in the UE assistance information (e.g., in step 410) or in another MAC CE or RRC signaling (e.g., UE capability reporting).

In some implementations, the UE 308 can revert/fall back to a previously-used model parameter set (e.g., parameter set 1) in response/subsequent to the parameter update. The fall back can be achieved by the gNB 306 to indicate at least parameter set ID in RRC or MAC CE signaling. In some cases, the usage (e.g., ability to use) of the indication (e.g., parameter set ID) from the gNB 306 may be based on/dependent on at least the capability of the UE 308, such as whether the UE 308 supports/stores/maintains multiple sets of parameters. In some other cases, the capability of the UE 308 to utilize the indication of parameter set ID may be based on a maximum number of parameters that the UE 308 can support or store, such as whether the UE 308 can store at least parameter set 1, parameter set 2, etc. Hence, the gNB 306 and/or the UE 308 can deploy, update, and/or train the AI model using one or more parameter sets (e.g., parameter set 1 and/or parameter set 2) based on at least performance loss, model status, assistance information, and/or UL RS to improve at least wireless communication quality in various aspects between the gNB 306 and the UE 308. Accordingly, the gNB 306 and/or the UE 308 can implement the AI model and adapt to the propagating/dynamic environment (e.g., due to UE 308 changes and beam shifts) to achieve higher accuracy (e.g., accounting for the UE 308 current and subsequent location), higher capacity, higher reliability, higher robustness, lower overhead, and/or lower latency via the use of the updated model synced between the gNB 306 and the UE 308.

### B. Implementation 2: Model Management With Online Training

Referring to FIG. 5, depicted is an example flow chart 500 for model management with online training. Performing online training for the model can include a cost of real-time or in-band resources of the air interface (e.g., network resources) of wireless communications, such as between the gNB 306 and the UE 308. For instance, the gNB 306 and/or the UE 308 can use the air interface resources to transmit data for training the model. In some instances, the gNB 306 and/or the UE 308 can use the air interface to participate/acquire in the model training, such as in collaborative training when the model is deployed on both UE 308 and gNB 306 sides. The model management with online training can include at least the gNB 306 i) triggering the online training procedure upon detecting/obtaining/receiving an indication for an update (e.g., a need for an update), and/or ii) generating training data based on measuring the UL RS from UE 308 (or other UEs 308 within the cell or a sub-region of the cell) or based on assistance information reporting from UE 308. In some cases, the training may involve the UE 308, such as when deploying the model on the UE-side, or both UE 308 and gNB 306 sides). In this case, the gNB 306 may transmit/send/provide the training data to UE through the air interface. In some cases, the air interface can include, correspond to, or be a part of the communication link 110 or communication channel 250 in conjunction with at least FIGS. 1-2, for example.

Certain steps within the flow diagram 500 can correspond to or include features or functionalities similar to certain steps of flow diagram 400 in conjunction with FIG. 4. For instance, steps 502-510 can include features corresponding to, as part of, or in addition to steps 402-410, respectively, of the model management operations without online training. In some implementations, the executing/performing/initiating model management with online training may use/include any subset of the steps/operations and/or in any order.

At step 502, the gNB 306 can configure/deploy parameter set level 1 (e.g., parameter set 1 or parameter set 302), which may be acquired based on offline training or historical/previous online training. The parameter set level 1 can be used as a baseline performance for one or more UEs 308 in one or more cells to determine any loss in wireless communication performance. The deployment of the parameter set 1 can include the gNB 306 transmitting/configuring the parameters in parameter set 1 to the UE 308 through RRC or MAC CE signaling. In some cases, the deployment can include the gNB 306 configuring a model ID or parameter set ID to the UE 308 in RRC or MAC CE signaling. For example, the gNB 306 can transmit the model or parameter set ID to the UE 308 in response/subsequent to the UE 308 entering the cell or based on the gNB configuration.

At step 504, the gNB 306 and/or the UE 308 can identify performance loss from the model parameter set 1 (e.g., performance loss at the baseline performance level). The identification of the performance loss can be on or identified/determined at the UE or gNB side. For instance, the UE 308 and/or gNB 306 can identify the performance loss based on monitoring one or more metrics (e.g., parameters, characteristics, features, or events) of the wireless system. For example, the UE 308 can monitor the reception performance of some DL channels and/or signaling based on metrics, such as PDSCH SNR, BLER, MCS, or CQI, among others. If the performance loss is identified by the UE 308, the procedure can proceed to step 506. In some cases, if the performance loss is identified by the gNB 306, the procedure can proceed to step 508.

At step 506, the UE can report a triggering online training request (e.g., request for online training). The report can include or correspond to a training request. The report may be included/contained/embedded in UCI (e.g., CSI) carried in/via a PUSCH or PUCCH. In some cases, the report may be included in MAC CE signaling carried in a PUSCH. Prior to transmission in the PUSCH, the UE 308 may transmit an SR carried in a PUCCH or PUSCH to the gNB 306. In response to receiving the SR, the gNB 306 can schedule a PUSCH to carry/include the MAC CE signaling, including the report from the UE 308. In some cases, the report may be jointly coded with SR in one or more SR resources or PUCCH resources for SR.

In some implementations, the report can include or correspond to a reporting of the measurement result, or an indicator (e.g., model status indicator) when the measurement result satisfies a threshold (e.g., lower or higher than, and/or equal to the threshold). The threshold may be predetermined/fixed or configured by the gNB 306. The measurement results can include at least PDSCH SNR, BLER, MCS, CQI, among other parameters. In some cases, the gNB 306 may configure a dedicated set of RSs (e.g., PDSCH DMRSs or CSI-RSs) for measuring the parameters or quality of signaling between the gNB 306 and the UE 308, for example.

For example, if the UE 308 reports measurement results, the report may be included in a periodic report in UCI carried in PUSCH/PUCCH or MAC CE signaling carried in PUSCH. In some cases, the report may include or correspond to an aperiodic UCI report in a PUSCH or PUCCH or MAC CE signaling carried in a PUSCH. In this case, prior to transmission of the MAC CE signaling in a PUSCH, the UE 308 may transmit/send an SR carried in a PUCCH or PUSCH to the gNB 306. Hence, the gNB 306 can schedule a PUSCH to carry the MAC CE signaling from the UE 308 including the report.

If the report corresponds to a reporting of an indicator when the measurement result satisfies the threshold, the report may be a UCI (e.g., CSI) in PUSCH or PUCCH. In some cases, the report can be included/contained in the MAC CE signaling carried in a PUSCH. Prior to transmission of the MAC CE signaling in the PUSCH, the UE 308 can transmit an SR carried in a PUCCH or PUSCH for the gNB 306. The gNB 306 can schedule a PUSCH to carry the MAC CE signaling for the UE 308 accordingly. In some cases, the report may be jointly coded with SR in one or more SR resources or PUCCH resources for SR.

At step 508, the gNB 306 can trigger an online training process, such as in response to the gNB 306 identifying the performance loss. In some cases, the gNB 306 can trigger the online training process in response to an indication, reporting, or training request from the UE 308, such as from step 506. The triggering of the online training process can be indicated in at least one of RRC, MAC CE, or DCI signaling, among others. In some cases, the gNB 306 can trigger the process to initiate UE reporting of the UE assistance information or UL RS transmission.

In some implementations, the UE 308 may not receive the trigger signaling (e.g., a second indication) from the gNB 306 within L mini-seconds, L slots, or L OFDM symbols, subsequent to/after the UE 308 transmits/sends the training request. The L can include or represent a predetermined value or indicated by the gNB signaling, for example. In response to not receiving the triggering signaling from the gNB 306 within the predetermined time frame, the UE 308 may re-send/re-transmit the training request or report to the gNB 306.

At step 510, the UE 308 can transmit assistance reporting or UL RS transmission upon/in response to/subsequent to receiving gNB triggering, such as triggering of the model training (e.g., in this case, the online training process). The UE 308 can initiate/start the transmission of UL RS (e.g., SRS) or assistance information at the slot or OFDM symbol which may be N mini-seconds, N slots, or N OFDM symbols subsequent to receiving the triggering, or N mini-seconds, N slots, or N OFDM symbols subsequent to transmitting the HARQ-ACK of the PDSCH or PDCCH including/containing the triggering signaling. The N can include, correspond to, or represent a fixed/predetermined/predefined value/quantifier or indicated in a gNB signaling. For instance, the N can be indicated in the triggering signaling from the gNB 306 (e.g., MAC CE or DCI), such as from step 508.

The UL RS and/or assistance information may include one occasion for locating N mini-seconds, N slots, or N OFDM symbols after receiving the triggering from the gNB 306, or N mini-seconds, N slots, or N OFDM symbols after/subsequent to the UE 308 transmitting the HARQ-ACK of the PDSCH or PDCCH containing the triggering signaling to the gNB 306. In some cases, the pattern of the UL RS or assistance information report from the UE 308 can be predetermined or configured by gNB signaling. The pattern may include at least the periodicity of the UL RS or assistance information report, the number of occasions (e.g., the number of times or the frequency) of the UL RS or assistance information report, and/or the time gap (e.g., time frame or period) between two adjacent occasions of the UL RS or assistance information report.

In some implementations, the gNB 306 can configure the CSI report configuration resource and/or SRS resource set information associated with/in regards to the model training usage, procedures, or operations. In some implementations, the gNB 306 can utilize the signaling (e.g., MAC CE), such as the signaling that carries/includes/provides training data to the UE 308 (e.g., in conjunction with at least one of steps 512 and/or 514), or in new dedicated signaling, to terminate/end the UL RS transmission or assistance information reporting from the UE 308.

The gNB 306 can use the content of the assistance information report to generate the training data which matches/correlates/is comparable to channel properties of the UE 308, such that the gNB 306 and the UE 308 can use, train, or update a similar model to enhance the wireless system. For instance, the information (e.g., assistance information) from the UE 308 can include/contain/relates to a location/region/position of the UE 308 within one or more cells (e.g., a cell associated with the gNB 306 or other gNBs 306). For instance, the information can include at least the TA, RTT, DL AoD, or TDOA, among others.

In some implementations, the assistance information can include, be associated with, or relate to large-scale parameters of the UE 308. For example, the information can include at least average delay, delay spread, average angle, angular spread, average gain, etc. In some cases, the gNB 306 can configure a dedicated set of CSI-RS (or TRS) for measuring/determining/obtaining assistance information from the UE 308. In some cases, the gNB 306 can configure/provide the content of (or similar to) assistance information report.

In response to the UE 308 reporting the assistance information or transmitting the UL RS (e.g., SRS) to the gNB 306 to facilitate training data generation by the gNB 306, the online model training procedure can proceed to at least one of steps 512 or 514. For instance, if the training does not involve the UE 308 (e.g., the model deployed in the gNB side), the gNB 306 can implement/utilize/leverage the generated training data to train the model, such as performing the online training (e.g., step 512). In some cases, the training may involve the UE 308 (e.g., model deployed in the UE-side or both the gNB and UE sides, such as through collaborative operation. In this case, the gNB 306 and/or the UE 308 may include support for air interface, such as for delivery/transmission of training data from the gNB 306 to the UE 308 (e.g., steps 514 and 516).

For example, at step 514, the gNB 306 can transmit/provide/deliver the generated training data based on at least the assistance information or UL RS to UE 308 in a DL signaling (e.g., RRC or MAC CE signaling). In some cases, if the UE 308 does not receive such transmission signaling M mini-seconds, M slots, or M OFDM symbols after at least one of i) the transmission of the assistance information, ii) the transmission of UL RS, and/or iii) the transmission of the training request from the UE 308, the UE 308 can re-send the training request.

The training data can include or correspond to at least the input and/or output data used in the model, controlling factors (e.g., compression rate, learning rate, step interval, etc.) of the model, data structure (e.g., number of batches, etc.), and/or structure of the model (e.g., number of layers or nodes, weights of the layers or nodes, etc.). In some cases, the transmission of training data may use a compression mechanism (e.g., compression coding) to reduce the payload size, for instance, when the gNB 306 transmits the training data to the UE 308.

In some implementations, the transmission of the training data may utilize/include/implement a predetermined structure (e.g., model, codebook, etc.) to reduce the payload. The gNB 306 can quantize and/or compress the training data based on the predetermined structure and transmit the quantized data to the UE 308. Accordingly, upon receiving the quantized data, the UE 308 can reconstruct/extract/obtain/identify the training data based on the predetermined structure (e.g., model, codebook, etc. similarly used by the gNB 306 to quantize the training data) and the received data. For instance, the UE 308 can utilize the predetermined structure to extract the training data from the quantized data. The transmission of the training data may be carried in a SRB and/or control plane, for example.

At step 516, the UE 308 can perform the online training of the model based on the received or reconstructed/recovered training data from the gNB 306. In some cases, the UE 308 and the gNB 306 can perform collaborative training based on the training data, for instance, during deployment of the model for both UE-side and gNB-side. In some implementations, for example, the UE 308 can fallback/revert to a previously-used model parameter set (e.g., parameter set 1 or parameter set 302) after using the trained model parameters. In some cases, the gNB 306 can perform the fallback procedures (e.g., similar to the UE 308) to indicate the trained parameter set ID in RRC or MAC CE. The gNB 306 can transmit the trained parameter set ID to the UE 308, such that the UE 308 can obtain a parameter set based on the ID. The indication from the gNB 306 (e.g., indication of the parameter set ID) can be used by the UE 308 based on the capability of the UE 308, such as whether the UE support or store multiple sets of parameters of and/or the maximum number of parameters the UE 308 can support or store. Hence, the gNB 306 and/or the UE 308 can perform online training for the model to facilitate and improve the wireless system, such as communication between devices, nodes, or entities.

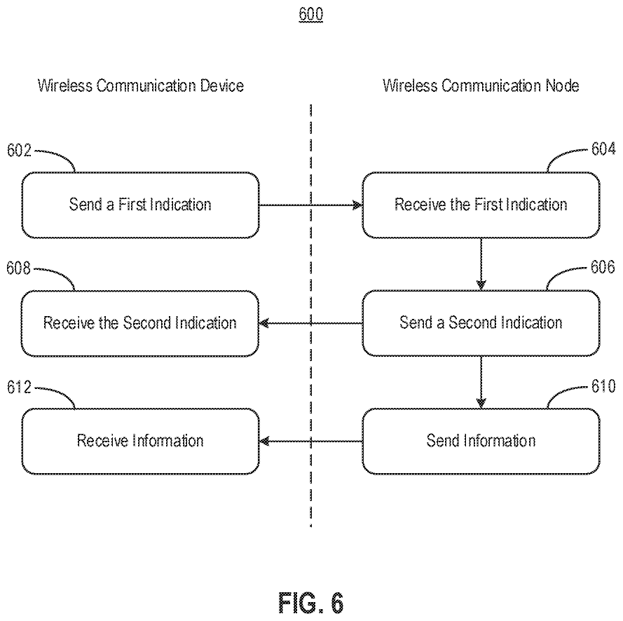

FIG. 6 illustrates a flow diagram of an example method 600 for model management. The method 600 can be implemented using any of the components and devices detailed herein in conjunction with FIGS. 1-5. In overview, the method 600 can include a wireless communication device sending a first indication (602). The method 600 can include a wireless communication node receiving the first indication (604). The method 600 can include the wireless communication node sending a second indication (606). The method 600 can include the wireless communication device receiving the second indication (608). The method 600 can include the wireless communication node sending information (610). The method 600 can include the wireless communication device receiving the information (612).

Referring to operation (602), the wireless communication device (e.g., UE) can send/transmit/report a first indication to the wireless communication node (e.g., BS or gNB). The wireless communication device can send the first indication to initiate an update and/or training of the model. The model may include, correspond to, or be a part of an AI model on at least one of CSI reporting, beam management, channel estimation, positioning, mobility, scheduling, channel coding, among others. At operation (604), the wireless communication node can receive the first indication from the wireless communication device.

The first indication can include at least a request to update a parameter set (e.g., parameter set level 1, parameter set level 2, etc.) of the model. In some cases, the first indication can include a request to train the model. In some implementations, the first indication can include/contain at least one of a measurement result or an indication of measurement result satisfying a threshold criterion or threshold criteria. The threshold may include a range, such as an upper bound/limit or a lower bound/limit. To satisfy the threshold, the measurement result may be lower than, higher than, and/or equal to the threshold. In some cases, satisfying the threshold criteria may be associated with failing to meet a threshold range, such as being outside/beyond the threshold range. The measurement result can include at least one of a signal-to-noise ratio (SNR) of a physical downlink shared channel (PDSCH), a block error rate (BLER), a modulation and coding scheme (MCS), and/or a channel quality indicator (CQI). In some cases, the wireless communication node may configure a dedicated set of RS (e.g., PDSCH DMRS or CSI-RS) for measuring the parameters or determining the measurement results.

In some implementations, the first indication may be included in at least one of a periodic report, uplink control information (UCI), or a medium access control control element (MAC CE) signaling. In some cases, the first indication may be carried in a first physical uplink shared channel (PUSCH) or physical uplink control channel (PUCCH). In some cases, the first indication may be jointly coded with a scheduling request (SR) in at least one SR resources or at least one PUCCH resources for the SR. In some cases, the first indication may be included as part of an aperiodic UCI report in PUSCH or PUCCH, or MAC CE signaling carried in a PUSCH. Prior to/before transmitting the MAC CE signaling in a PUSCH, the wireless communication device may transmit/send an SR carried in PUCCH or PUSCH to the wireless communication node, such that the wireless communication node can schedule a PUSCH to carry the MAC CE signaling. The wireless communication device may send an SR carried in a second PUSCH or PUCCH prior to/before sending the first indication in the MAC CE signaling that is carried in the PUSCH.

In some implementations, the wireless communication device may not receive the second indication within a defined/fixed/predetermined duration/timeframe, such as after/subsequent to sending the first indication. The defined duration may be L mini-seconds, L slots, or L OFDM symbols, which may be indicated or provided by the wireless communication node or based on the wireless communication node configuration. In response to the delayed second indication, the wireless communication device may re-send, responsive to the defined duration, the first indication to initiate an update or training of the model to the wireless communication node. In some cases, the UL transmission (e.g., UL RS or assistance information) may include/contain one occasion which locates (e.g., for the wireless communication device) a defined duration (e.g., N mini-seconds, N slots, or N OFDM symbols) after/subsequent to receiving the triggering, or N mini-seconds, N slots, or N OFDM symbols after transmitting a HARQ-ACK of the PDSCH or PDCCH containing the triggering signaling.

At operation (606), the wireless communication node can send a second indication to the wireless communication device. The wireless communication node may send the second indication in response/after/subsequent to receiving the first indication. At operation (608), the wireless communication device can receive the second indication from the wireless communication node. The second indication can be used to trigger an uplink (UL) transmission or indicate for the wireless communication device to initiate the UL transmission. The UL transmission can include, correspond to, or be a part of a UL reference signal (RS) transmission or transmission of assistance information report from the UE.

For instance, the UL transmission can include at least one of UL transmission of at least one RS or a report including/containing assistance information (e.g., to provide information to assist with training or updating the model). In some implementations, the assistance information can include information related to a relative location/position/region of the wireless communication device in one or more cells. For example, the information related to a relative location of the wireless communication device in one or more cells can include at least one of time advance (TA), round trip time (RTT), angle of departure (AoD), or time difference of arrival (TDOA), among others.

In some implementations, the assistance information can include information related to at least one large-scale parameter of the wireless communication device. For instance, the information related to at least one large scale parameter of the wireless communication device comprises at least one of average delay, delay spread, average angle, angular spread, or average gain, among others. In some implementations, the wireless communication node can configure a dedicated set of CSI-RS or TRS for measuring the assistance information. In some cases, the wireless communication node may configure/modify/generate the content of the assistance information report.

In some cases, the wireless communication device can receive the second indication in one of a radio resource control (RRC), medium access control control element (MAC CE) or downlink control information (DCI) signaling from the wireless communication node. In response to/upon receiving the second indication for instance, the wireless communication device may perform/execute/initiate the UL transmission to the wireless communication node. In some implementations, the wireless communication device can perform the UL transmission a predetermined/defined/configured duration (e.g., N mini-seconds, N slots, or N OFDM symbols) i) in response to/subsequent to/after receiving the second indication from the wireless communication node or ii) after transmitting a hybrid automatic request acknowledgment (HARQ-ACK) of a physical downlink shared channel (PDSCH) or physical downlink control channel (PDCCH) carrying the second indication to the wireless communication node. The defined duration may be a fixed value or indicated in wireless communication node signaling. For instance, the N for N mini-seconds, N slots, or N OFDM symbols can be indicated in triggering signaling (e.g., MAC CE or DCI).

In some cases, the UL transmission may include a pattern. The pattern of the UL transmission may be predefined/configured/predetermined/fixed via signaling from the wireless communication node. In some other cases, the pattern may include at least one of a periodicity of the UL transmission, a number of occasions (e.g., number of times or frequency) of the UL transmission, or a time gap between adjacent occasions of the UL transmission.

At operation (610), the wireless communication node can send information for updating the model to the wireless communication device. The wireless communication node may send the information in response to/after/subsequent to at least one of transmission of the second indication or triggering of UL transmission from the wireless communication device. At operation (612), the wireless communication device can receive the information for updating the model from the wireless communication node. The information can be for updating the model, such as training data or updated model parameter set. For instance, the information for updating the model can include at least one of training data for training the model, or an updated parameter set for the model or an indication (e.g., parameter set ID for obtaining the parameter set) thereof, etc.

In some implementations, the wireless communication device can receive the information for updating the model from the wireless communication node via a radio resource control (RRC), medium access control control element (MAC CE), or downlink control information (DCI) signaling. In some cases, if the wireless communication device does not receive the information for updating the model within a defined duration (e.g., M mini-seconds, M slots, or M OFDM symbols) after sending/transmitting/providing the UL transmission or the first indication (e.g., request for training or updating the model), the wireless communication device may re-send the first indication to the wireless communication node, such as to initiate an update or training of the model.

In some implementations, the training data can include the input and/or output data used in the model, such as controlling factors (e.g., compression rate, learning rate, step interval, etc.) of the model, data structure (e.g., number of batches, etc.), or structure of the model (e.g., number of layers or nodes, weights of the layers or nodes, etc.). In some implementations, the model parameter set can include at least coefficients/values/quantifiers used in the model, controlling factors (e.g., compression rate, activation function, etc.) of the model, or structure of the model (e.g., number of layers or nodes, weights of layers or nodes, etc.).

In some implementations, the updated parameter set for the model can include at least a subset of a current parameter set for the model. For instance, one or more parameters within the current parameter set may not require changes. Hence, the updated parameter may include a certain amount of delta/differences and similarities to the current parameter set. In some implementations, the wireless communication node can configure at least one of a channel state information (CSI) configuration, information on sounding reference signal (SRS) resource or SRS resource set, associated with updating the parameter set of the model or training the model.

In some cases, the wireless communication device can terminate/end the UL transmission in response to receiving a signaling from the wireless communication node. The signaling can include at least one of the information for updating the model or defined signaling (e.g., dedicated signaling), among others. In some cases, the wireless communication device can receive at least one signaling carrying a compressed or quantized version of the information for updating the model from the wireless communication node. The compressed or quantized version of the information can reduce the payload or bandwidth for wireless communication. The wireless communication device can receive the quantized version (e.g., digitization of analog data) of the information in multiple pieces/portions/intervals. In some implementations, the wireless communication device can recover/extract/identify/determine/obtain the information for updating the model from the compressed or quantized version, using a predetermined structure. The predetermined structure (e.g., used by the wireless communication node and/or wireless communication device) can include at least the model or codebook for quantization or compression of the training data.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
sending, by a wireless communication device to a wireless communication node, a first indication to initiate an update of a model;
receiving, by the wireless communication device from the wireless communication node, a second indication to trigger an uplink transmission; and
receiving, by the wireless communication device from the wireless communication node, information for updating the model.

2. The method of claim 1, wherein the first indication comprises a request to update a parameter set of the model or to train the model.

3. The method of claim 1, wherein the first indication comprises:
a measurement result, or
an indication of the measurement result satisfying a threshold criteria,
wherein the measurement result includes a signal-to-noise ratio (SNR) of a physical downlink shared channel (PDSCH), a block error rate (BLER), a modulation and coding scheme (MCS), or a channel quality indicator (CQI).

4. The method of claim 2, wherein the first indication is at least one of:
included in a periodic report,
included in uplink control information (UCI),
included in a medium access control control element (MAC CE),
carried in a first physical uplink shared channel (PUSCH) or physical uplink control channel (PUCCH), or
jointly coded with a scheduling request (SR) in at least one SR resource or at least one PUCCH resource for the SR.

5. The method of claim 4, comprising:
sending, by the wireless communication device prior to sending the first indication in the MAC CE that is carried in the PUSCH, an SR carried in a second PUSCH or PUCCH.

6. The method of claim 1, wherein the uplink transmission comprises:
an uplink transmission of at least one reference signal (RS), or
a report comprising assistance information.

7. The method of claim 6, comprising:
receiving, by the wireless communication device from the wireless communication node, the second indication in a radio resource control (RRC), medium access control control element (MAC CE) or downlink control information (DCI) signaling; and
performing, by the wireless communication device, the uplink transmission to the wireless communication node, responsive to the second indication.

8. The method of claim 6, comprising:
performing, by the wireless communication device, the uplink transmission a defined duration after receiving the second indication or after transmitting a hybrid automatic request acknowledgment (HARQ-ACK) of a physical downlink shared channel (PDSCH) or physical downlink control channel (PDCCH) carrying the second indication.

9. The method of claim 6, wherein if the wireless communication device does not receive the second indication within a defined duration after sending the first indication, the method further comprises:
resending, by the wireless communication device to the wireless communication node, the first indication to initiate an update of the model.

10. The method of claim 6, wherein at least one of:
a pattern of the uplink transmission is predefined or configured via a signaling from the wireless communication node, or
the pattern includes at least one of: a periodicity of the uplink transmission, a number of occasions of the uplink transmission, or a time gap between adjacent occasions of the uplink transmission.

11. The method of claim 6, wherein the wireless communication node configures at least one of: a channel state information (CSI) configuration, or information on sounding reference signal (SRS) resource or SRS resource set, associated with updating the parameter set of the model or training the model.

12. The method of claim 6, comprising:
terminating, by the wireless communication device, the uplink transmission responsive to receiving: a signaling comprising the information for updating the model, or a defined signaling.

13. The method of claim 6, wherein the assistance information comprises at least one of:
information related to a relative location of the wireless communication device in one or more cells,
information related to at least one large scale parameter of the wireless communication device, or
information related to a model structure of the wireless communication device.

14. The method of claim 13, wherein the information related to a relative location of the wireless communication device in one or more cells comprises at least one of:
time advance (TA), round trip time (RTT), angle of departure (AoD), or time difference of arrival (TDOA).

15. The method of claim 13, wherein the information related to the at least one large scale parameter of the wireless communication device comprises at least one of:
average delay, delay spread, average angle, angular spread, or average gain.

16. The method of claim 13, wherein the information related to the model structure comprises at least one of a first number of nodes, a number of layers, or a second number of nodes for each layer.

17. The method of claim 1, wherein the information for updating the model comprises: training data for training the model, or an updated parameter set for the model or an indication thereof.

18. A wireless communication device, comprising:
at least one processor configured to:
send, via a transceiver to a wireless communication node, a first indication to initiate an update of a model;
receive, via the transceiver from the wireless communication node, a second indication to trigger an uplink transmission; and
receive, via the transceiver from the wireless communication node, information for updating the model.

19. A method comprising:
receiving, by a wireless communication node from a wireless communication device, a first indication to initiate an update of a model;
sending, by the wireless communication node to the wireless communication device, a second indication to trigger an uplink transmission; and
sending, by the wireless communication node to the wireless communication device, information for updating the model.

20. A wireless communication node, comprising:
at least one processor configured to:
receive, via a transceiver from a wireless communication device, a first indication to initiate an update of a model;
send, via the transceiver to the wireless communication device, a second indication to trigger an uplink transmission; and
send, via the transceiver to the wireless communication device, information for updating the model.
